(19) United States
(12) Patent Application Publication
(10) Pub. No.: US 2013/0154376 A1
(43) Pub. Date: Jun. 20, 2013

(54) UNINTERRUPTIBLE POWER SUPPLY

(71) Applicants: HSIAO-PING HSUEH, Tu-Cheng (TW); YU-CHI TSAI, Tu-Cheng (TW)

(72) Inventors: HSIAO-PING HSUEH, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 13/439,919

(22) Filed: Apr. 5, 2012

(30) Foreign Application Priority Data
Dec. 15, 2011 (TW) 100146442

(51) Int. Cl. H02J 9/00

(52) U.S. Cl. 307/65; 307/64

(57) ABSTRACT

An uninterruptible power supply (UPS) includes a rectifier, a converter, a first auxiliary power source, and a power distribution unit (PDU). The rectifier receives an alternating current (AC) voltage from an AC power source and converts this to a rectified direct current (DC) voltage which is outputted to the converter. The converter converts the rectified DC voltage to a working voltage and outputs the working voltage to a power supply unit (PSU) through the PDU. The first auxiliary power source outputs a DC voltage to the PSU through the PDU when the AC power source is down.

### CROSS-REFERENCE OF RELATED ART

Relevant subject matter is disclosed in a pending U.S. patent application with application Ser. No. 13/428,014 filed on Mar. 23, 2012, with the same title “UNINTERRUPTIBLE POWER SUPPLY”, which is assigned to the same assignee as this patent application.

### BACKGROUND

1. Technical Field

The present disclosure relates to uninterruptible power supplies.

2. Description of Related Art

An uninterruptible power supply (UPS) may be placed outside a server cabinet, to provide power to the server cabinet when the alternating current (AC) power source is down. The UPS includes a main AC power source and an auxiliary power source, such as a battery. The main AC power source provides an AC voltage to the server cabinet and also provides a direct current (DC) voltage to charge the battery by a converter, which includes a buck circuit and a feedback circuit for converting the AC voltage to the DC voltage. When the main AC power source is down, the UPS switches from the main AC power source to the battery, to provide an AC voltage to the server cabinet through an inverter, which converts the DC voltage output from the battery to an AC voltage. However, the converter and the inverter of the UPS will add cost and energy consumption of the UPS. Therefore, there is room for improvement in the art.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a block diagram of an uninterruptible power supply (UPS) in accordance with an exemplary embodiment of the present disclosure.

FIG. 2 is a circuit diagram of a converter of the UPS of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

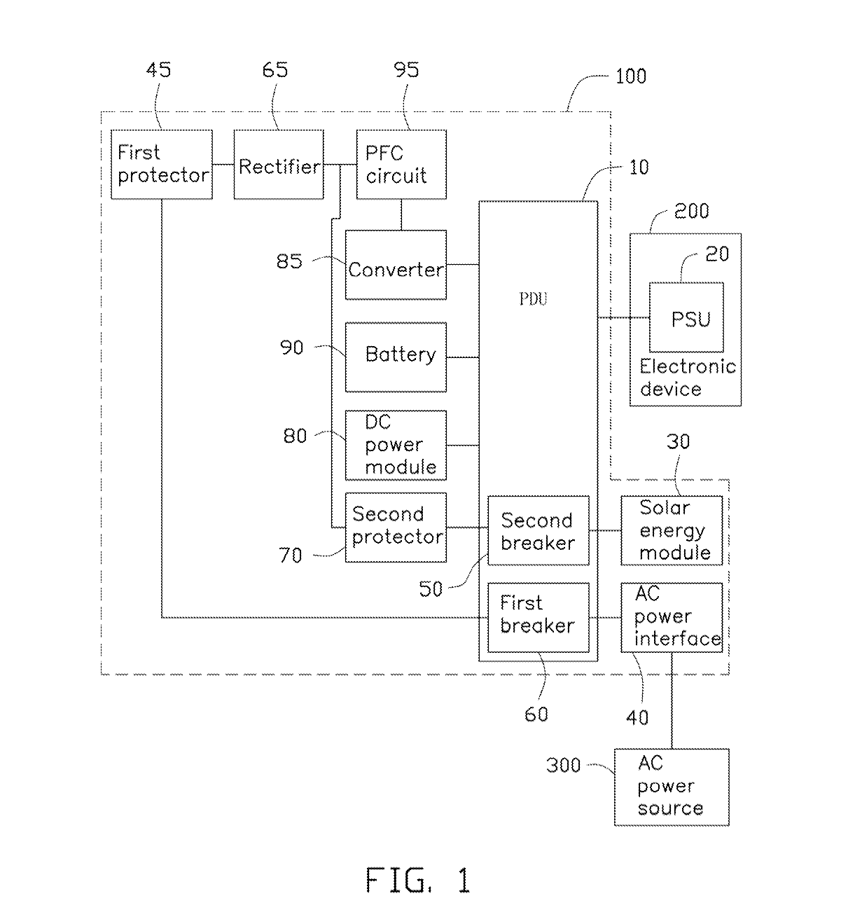

Referring to FIG. 1, an uninterruptible power supply (UPS) 100 is used for providing power to a power supply unit (PSU) 20 of an electronic device 200. The UPS 100 in accordance with an exemplary embodiment includes an alternating current (AC) power interface 40, a solar energy module 30, a battery 90, a direct current (DC) power module 80, first and second protectors 45 and 70, a rectifier 65, a power factor correction (PFC) circuit 95, a converter 85, and a power distribution unit (PDU) 10. The PDU 10 includes first and second breakers 60 and 50. The solar energy module 30, the battery 90, and the DC power module 80 are the auxiliary power sources of the UPS 100.

In one embodiment, the first and second breakers 50 and 60 are used for over-current protection. The first and second protectors 45 and 70 are electromagnetic relays. When an inrush current or a spike voltage of the UPS 100 is present, the protectors 45 and 70 cut off, to protect the UPS 100.

The AC power interface 40 is connected to an AC power source 300. The AC power interface 40 is also connected to an input terminal of the rectifier 65 through the first breaker 60 and the first protector 45. An output terminal of the rectifier 65 is connected to an input terminal of the converter 85 through the PFC circuit 95. An output terminal of the converter 85 is connected to a first input terminal of the PDC 10. The solar energy module 30 is connected to the output terminal of the rectifier 65 through the second breaker 50 and the second protector 70. The battery 90 is connected to a second input terminal of the PDU 10. The DC power module 80 is connected to a third input terminal of the PDU 10. An output terminal of the PDU 10 is connected to the PSU 20.

The rectifier 65 receives AC power from the AC power source 300 through the AC power interface 40 and converts the AC to DC, and outputs the DC voltage to the PFC circuit 95. The PFC circuit 95 receives the DC voltage from the rectifier 65 and regulates a power factor of the DC voltage, and outputs a regulated DC voltage to the converter 85. The converter 85 converts the regulated DC voltage to a working DC voltage, which accords with a voltage requirement of the PSU 20, and outputs the working DC voltage to the PSU 20 through the PDU 10.

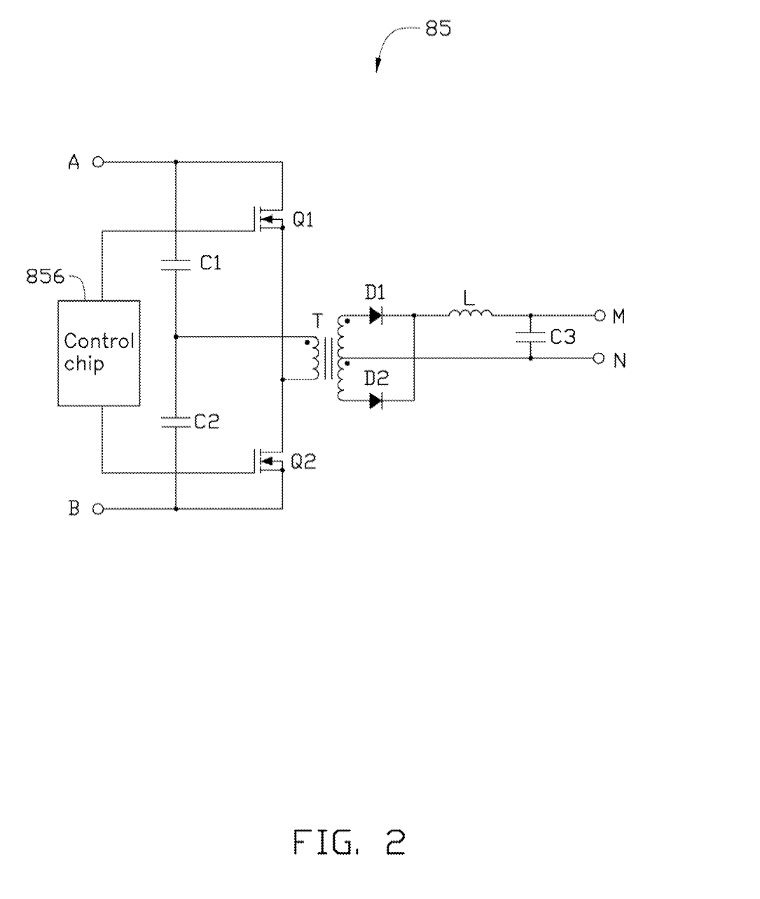

Referring to FIG. 2, the converter 85 includes capacitors C1-C3, field effect transistors (FETs) Q1 and Q2, a transformer T, diodes D1 and D2, an inductor L, a control chip 856, two voltage input terminals A and B connected to the PFC circuit 95, and two voltage output terminals M and N connected to the first voltage input terminal of the PDU 10. The voltage input terminal A is connected to a drain of the FET Q1. A gate of the FET Q1 is connected to the control chip 856. A source of the FET Q1 is connected to a drain of the FET Q2. A gate of the FET Q2 is connected to the control chip 856. A source of the FET Q2 is connected to the voltage input terminal B. The capacitors C1 and C2 are connected in series between the voltage input terminals A and B. A first end of a primary coil of the transformer T is connected to a node between the capacitors C1 and C2. A second end of the primary coil of the transformer T is connected to a node between the source of the FET Q1 and the drain of the FET Q2. A first end of a secondary coil of the transformer T is connected to an anode of the diode D1. A second end of the secondary coil of the transformer T is connected to an anode of the diode D2. Cathodes of the diodes D1 and D2 are connected to the voltage output terminal M through the inductor L. The voltage output terminal N is connected to a center tap of the transformer T. The capacitor C3 is connected between the voltage output terminals M and N. The FETs Q1 and Q2 of the converter 85 are used to isolate signal interference and the transformer T of the converter 85 is used to transform voltages. Thus, the converter 85 is able to replace a buck circuit and a feedback circuit together, which saves significantly in cost and energy.

The solar energy module 30, the battery 90, and the DC power module 80 provide DC voltages to the PSU 20 through the PDU 10 when the AC power source 300 is down. The solar energy module 30 receives solar energy and converts the solar energy to a first DC voltage, and outputs the first DC voltage to the PFC circuit 95. The PFC circuit 95 regulates the power factor of the first DC voltage and outputs the regulated voltage to the converter 85. The converter 85 converts the regulated voltage to a working voltage and outputs the working voltage to the PSU 20 through the PDU 10. The DC power module 80 and the battery 90 output DC voltages to the PSU 20 through the PDU 10.

The solar energy module 30, the DC power module 80, and the battery 90 are auxiliary power sources for directly providing DC voltages to the PSU 20 through the PDU 10 when the AC power source 300 is down, which improve reliability of the UPS 100. At the same time, the converter 85 of the UPS 100 avoids using buck circuits and feedback circuits, to save cost and energy.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An uninterruptible power supply (UPS) applicable to a power supply unit (PSU) of an electronic device, the UPS comprising:
an alternating current (AC) power interface connected to an AC power source;
a rectifier converting an AC voltage received from the AC power interface to a rectified direct current (DC) voltage;
a converter converting the rectified DC voltage to a working DC voltage according to voltage requirement of the PSU of the electronic device;
a power distribution unit (PDU) connected to the converter to receive the working DC voltage and output the working DC voltage to the PSU; and
a first auxiliary power source, wherein when the AC power source is down, the first auxiliary power source outputs a voltage to the PSU according to voltage requirement of the PSU of the electronic device through the PDU.

2. The UPS of claim 1, wherein the converter comprising first to third capacitors, first and second field effect transistors (FETs), a transformer, first and second diodes, an inductor, a control chip, first and second voltage input terminals connected to the rectifier, and first and second voltage output terminals connected to the PDU, the first voltage input terminal is connected to a drain of the first FET, a gate of the first FET is connected to the control chip, a source of the first FET is connected to a drain of the second FET, a gate of the second FET is connected to the control chip, a source of the second FET is connected to the second voltage input terminal, the first and second capacitors are connected in series between the first and second voltage input terminals, a first end of a primary coil of the transformer is connected to a node between the first and second capacitors, a second end of the primary coil of the transformer is connected to a node between the source of the first FET and the drain of the second FET, a first end of a secondary coil of the transformer is connected to an anode of the first diode, a second end of the secondary coil of the transformer is connected to an anode of the second diode, cathodes of the first and second diodes are connected to the first voltage output terminal through the inductor, the second voltage output terminal is connected to a center tap of the transformer, the third capacitor is connected between the first and second voltage output terminals.

3. The UPS of claim 1, wherein the first auxiliary power source is a DC power module, and connected to the PDU.

4. The UPS of claim 1, further comprising a second auxiliary power source, wherein the second auxiliary power source is a solar energy module, and connected to an output terminal of the rectifier.

5. The UPS of claim 4, wherein the PDU comprises first and second breakers for over-current protection, the first breaker is connected between the AC power interface and the rectifier, the second breaker is connected between the solar energy module and the rectifier.

6. The UPS of claim 5, further comprising first and second protectors for over-current and over-voltage protection, wherein the first protector is connected between the first breaker and the rectifier, the second protector is connected between the second breaker and the rectifier.

7. The UPS of claim 1, further comprising a power factor correction circuit (PFC), wherein the PFC is connected between the rectifier and the converter.

8. The UPS of claim 1, further comprising a third auxiliary power source, wherein the third auxiliary DC power source is a battery, and connected to the PDU.
